(19) United States
(12) Patent Application Publication
(10) Pub. No.: US 2007/0294100 A1
(43) Pub. Date: Dec. 20, 2007

(54) High-performance matching and filtering for structured and semi-structured rules in real-time

(76) Inventors: Benjamin Chen, Escondido, CA (US); William Lindsey, Belmont, CA (US); Jason Oliver, Los Angeles, CA (US); Keith McAllister, Brooklyn, NY (US)

Correspondence Address: MORRISON & FOERSTER LLP, 1650 TYSONS BOULEVARD, SUITE 400, MCLEAN, VA, 22102, US

(21) Appl. No.: 11/727,399

(22) Filed: Mar. 26, 2007

Related U.S. Application Data
(60) Provisional application No. 60/785,273, filed on Mar. 24, 2006.

(51) Int. Cl. G06Q 30/00

(52) U.S. Cl. 705/1

(57) ABSTRACT

Systems and methods for online content syndication using high-performance matching and filtering for structured and semi-structured rules in real-time are disclosed. In one embodiment, the system provides a marketplace for publishers, editors and advertisers. It can harness the power of the Internet and XML to facilitate the sale and acquisition of articles, photos and graphics each with their own licensing rules. In one embodiment, the system provides a unique and powerful licensing engine that gives control over price, licensing rules, embargoes and exclusions across content—with an ability to adjust those rules for each individual asset. In one embodiment, the system combines advanced data management technology, a sophisticated search engine and e-commerce technologies to provide a novel solution to the syndication of content.

### CROSS-REFERENCE TO RELATED APPLICATIONS

This application claims priority from U.S. Provisional Patent Application Ser. No. 60/785,273, filed Mar. 24, 2006, the disclosure of which is hereby incorporated by reference in its entirety.

### BACKGROUND OF THE INVENTION

1. Field of the Invention

The invention relates generally to a media marketplace for feature content, and more particularly, to online systems and methods that facilitate commercial content syndication.

2. Description of Related Art

In a recent year, approximately 16.8 billion words and 1.8 billion photos and graphics were sold over wire services such as the Associated Press, Bloomberg and Reuters. When those numbers are combined with audio and video sales, global spending was just under $2 billion for syndicated news content in a recent year. This number is expected to grow to $3 billion by 2008.

In addition, niche publications will soon spend nearly $3 billion on outsourced content. Niche content is predicted to surpass general syndicated content by 2012. The explosion of blogs, websites and online newsletters promises to increase the market even further.

The complexity of licensing has always made content syndication difficult and presents content owners with barriers to re-monetizing content. Licensing is a manual process usually involving legal and licensing departments working to create individual contracts dealing with issues such as price, time, geographic embargoes, competitor exclusions and a host of additional licensing rules.

FIG. 1 shows an example of a known content syndication model. Content syndication remains a largely subscription-based business, the cost of which is prohibitive to entire market segments of potential content buyers.

Accordingly, a need exists to make content licensing and distribution easier and more affordable. One way to do this is by providing a solution to a major challenge facing content syndication today: the handling of complex licensing rules that allow for media to be bought and sold on a secure, a la carte basis worldwide, allowing content publishers to have control in developing new syndication partnerships.

### SUMMARY OF THE INVENTION

Systems and methods for online content syndication using high-performance matching and filtering for structured and semi-structured rules in real-time are disclosed. In one embodiment, the system enables revenue streams to content providers such as magazines, newspapers and wire services, while offering media outlets of various types an ability to buy feature content a la carte and on-demand.

In one embodiment, the system provides a marketplace for publishers, editors and advertisers. It can harness the power of the Internet to facilitate the sale and acquisition of articles, photos and graphics each with their own licensing rules.

In one embodiment, the system provides a unique and powerful licensing engine that gives control over price, licensing rules, embargoes and exclusions across content—with an ability to adjust those rules for each individual asset. In one embodiment, the system combines advanced data management technology, a sophisticated search engine and e-commerce technologies to provide a novel solution to the syndication of content.

One embodiment includes a content syndication system, comprising a server computer, a client device, a plurality of distributed content storage devices and a licensing engine associated with the server computer, the client device and the content storage device. The licensing engine is configured to communicate with the server computer, the client device and the content storage device.

Another embodiment is a method of content syndication comprising providing content from a content provider to a content syndication service, establishing a price for the content, associating licensing rules with the content, selling the content to a buyer when the price and licensing rules have been met, providing the content to the buyer, providing a share of the revenue to the content provider from selling the content, and providing a share of the revenue to the content syndication service.

As will be realized, this invention is capable of other and different embodiments, and its details are capable of modification in various obvious respects, all without departing from this invention. Accordingly, the drawings and descriptions are to be regarded as illustrative in nature and not as restrictive.

### BRIEF DESCRIPTION OF THE DRAWINGS

FIG. 1 shows an example of a known content syndication model.

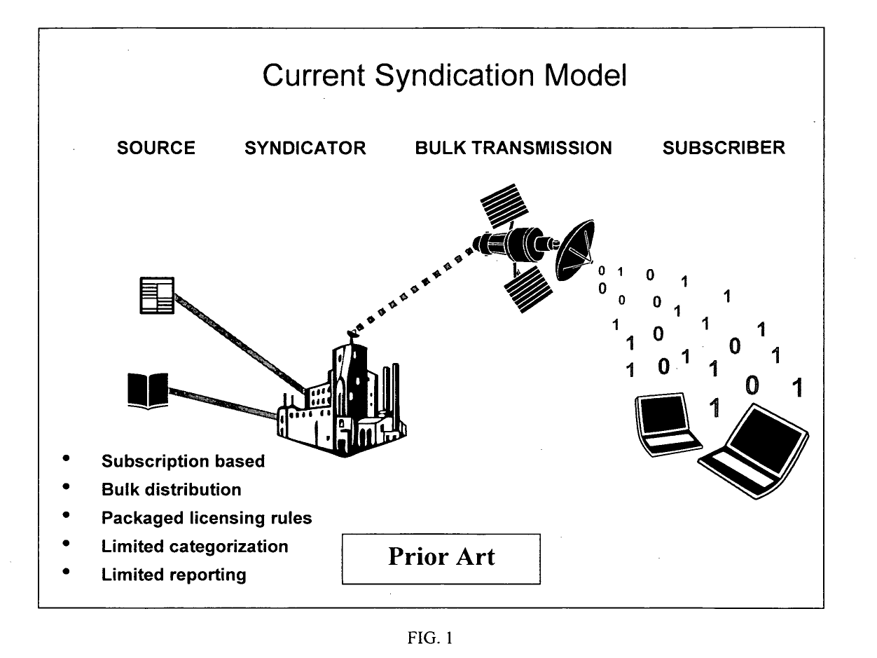

FIG. 2 shows an example of a high-level overview of one embodiment for online content syndication.

### DETAILED DESCRIPTION OF THE INVENTION

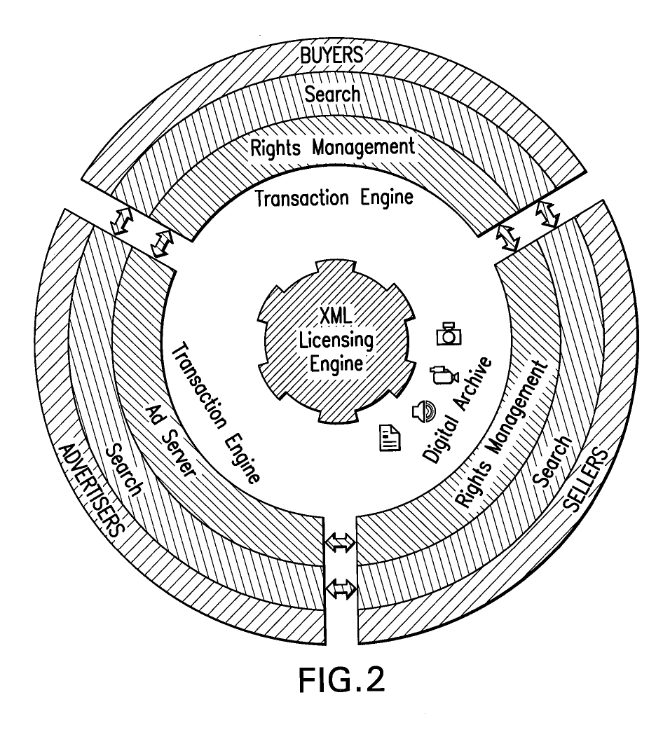

FIG. 2 shows an example of a high-level overview of one embodiment for online content syndication. In this embodiment, content syndication may be facilitated in a peer-to-peer fashion. In this embodiment, FIG. 2 shows that a licensing engine may interact with three business perspectives that correspond to different views of the content syndication process and that each of these perspectives may interact with the others. In this embodiment, these business perspectives may include sellers and buyers of content and advertisers.

In this embodiment, aspects of the present invention may be implemented on one or more computers executing software instructions. According to one embodiment of the present invention, server and client computer systems transmit and receive data over the Internet, a computer network or standard telephone line. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

In this embodiment, the instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers.

In this embodiment, editors and publishers from media outlets may be provided with access to a vast inventory of content from, for example, magazines, newspapers and websites. In this embodiment, a secure online media marketplace lets editors and publishers quickly search and buy content a la carte and on demand.

In this embodiment, a seller may create and store content. Editors may be both buyers and sellers of content. In this embodiment, the seller prices the item, chooses licensing rules and lists any embargoes, exclusions or other desired restrictions. These rules can be customized down to the individual asset level. Non-limiting examples of what can be sold include articles, photographs, audio (mp3), video (high quality mpeg) and content sponsorship.

In this embodiment, a seller may specify exclusions on individual content assets which prevent some members from buying that content. These exclusions may be based upon qualities of the buyer such as print circulation or unique monthly web-site visitors, geographic location, the buyers target audience demographics, the buyer's identity or its parent organization's identity. The system may prevent buyers from obtaining content for which the seller has specified relevant exclusions.

In one embodiment, users may have access to archival media from quality news providers, the freelance market, editor-reviewed news wire services, editorial news content and public relations content.

In this embodiment, a buyer may log into a network and can search for content in different ways, including by keywords within an article, SIC codes of industries referenced by the article, regions, market segments (e.g., demographic, psychographic and behavioral), brand and data range. In one embodiment, the network may be the Internet. The buyer may find desired content and review the material (text, photo, etc.), price and licensing terms. In this embodiment, the buyer can also review the history and credibility of the content and the seller. The buyer may then purchase and quickly receive the content. The content may be downloaded onto a publishing system.

In this embodiment, users can buy exclusive, non-exclusive or even impaired (watermarked) rights to publish the content. Users may even download the content for free if they are willing to include sponsored advertising when they publish a story.

In this embodiment, the seller may then receive a share of revenue from the syndication transaction.

In this embodiment, online advertising and revenue-sharing opportunities may be present. Advertisers my have the opportunity to closely align advertising with relevant content. Buyers may choose to accept advertising and its related revenue. In this embodiment, when a buyer accepts advertising, content may be free, and the revenue from the advertising may be shared among the buyer, seller and content syndication provider.

In this embodiment, once a story is decided upon, an advertiser chooses the type of ad to run. For print articles, this may include, for example, billboards and banner advertisements (appearing above, below and around the text), direct links (appearing below the article in the “sponsored by . . . ” line) and in-line ads (appearing as direct links within the story). For audio and video clips, advertisers may insert leading or trailing advertisements into the digital stream. With video clips, advertisers have the opportunity to place a semi-transparent banner or ticker, for example, with the advertising messages at the bottom of the screen.

In this embodiment, sponsored content may be available for free to users who become members of a content syndication service. In this embodiment, members using sponsored content on the internet may have the option of “opting out” and paying full price for the content. In this embodiment, members using sponsored content on the internet may get paid for “click throughs” where readers click on an ad and go to the advertiser's website. In this embodiment, by offering a portfolio of content options, members may have access to a range of content without financial constraint. In this embodiment, advertisers can attach their ads to a bundle of material related to their product or target market which may be then distributed free of charge. Customers can elect to either accept these terms or pay for the content directly. In this embodiment, the operator of the content syndication system can earn a percentage of the sale in both instances.

In this embodiment, the decision of which ad to place with a given piece of content may be made at the time a user's web browser fetches the web-page containing the content. The system may use qualities from all three of the buyer, the seller and the advertiser's stated preferences in determining which advertisement may provide the optimal revenue for all three parties.

In this embodiment, there may be transaction-based pricing. Members may not need to form complex contractual relationships. Members may not need to pay large subscription fees. In this embodiment, members selling content may be charged a transaction fee. In this embodiment, the selling member may set the price for the content. In this embodiment, members may have the option of pricing for non-exclusive or exclusive rights to the content.

In this embodiment, when a member makes the content ready for sale, the member may be given an approximate price that a wire service would charge for the same article (for example, based on number of words, add-ons and whether it is national or local story). Members who wish to purchase the content may see the price associated with their circulation levels (for example, based on an audit of their circulation levels). In this embodiment, members with higher circulation levels may pay more for content than lower circulation members. In this embodiment, membership that allows one to use the system may be free or may require a fee.

In this embodiment, when a member makes content ready for sale, the member may offer different pricing for the content to different buyers based upon the geographic location of the buyer, print circulation or unique monthly veiwership of a website or other qualities of the buyer of which the system is aware.

In this embodiment, the system may offer a place to sell archival assets. Giving value to these assets, especially photos and graphics, may provide revenue streams to small publications and broadcasters with archival assets.

In this embodiment, the system may provide for power sellers in the freelance market, allowing high-quality (based on purchase and peer review) writers the chance to spotlight their content before large prestigious buyers.

In this embodiment, bundles, or custom news packages or “wires” of text, audio and video clips, graphics, photographs and web links may be available for purchase. In this embodiment, buyers may purchase an entire bundle or selected pieces of it. In this embodiment, these packages may be pushed out to members via e-mail, a web page or an RSS feed, for example. Users may have the ability to view a synopsis of the package contents before deciding whether to purchase. In this embodiment, users can refine their news wires to get the content they need, when they need it.

In this embodiment, a publisher or broadcaster may have the freedom to buy only what they need at a fair market rate, rather than, for example, paying high membership fees to a known wire service and being deluged with content they don't need or leaving the wire service and paying story-by-story.

In this embodiment, content providers may be given a source rank based on publishing history. Freelance journalists may be ranked based on Lexis-Nexis entries, for example. Magazines and newspapers may be ranked based on circulation. Bloggers may be ranked based on readership. In this embodiment, the source rank may also include a subjective component. Members who have purchased content from a provider may rank the reliability of the source, for example. Similarly, editors for the content syndication system may review, comment and score particular pieces as a provider's content gets bundled in the custom wires. In this embodiment, the objective and subjective scores may be summed to create a content provider's source rank.

In this embodiment, members purchasing content may have the ability to comment on the content and assign a rating. In this embodiment, this could be a rating of one to five stars, with five stars indicating the highest content rating. In this embodiment, the comment may take the form of editorial criticism (e.g., poor punctuation, poor verb agreement, excess length, etc.), affirmation (e.g., validation of referenced sources, compliments, kudos) or even exposure (e.g., cross-referenced stories, incorrect assumptions, misspellings or general factual corrections). In this embodiment, these comments may be limited to the content and context of the story, graphic or photo.

In this embodiment, the system may use and ASP model, hence buyers and sellers may be able to get started by logging in over the internet using a web browser.

In this embodiment, security of digital assets, which may also be known as digital rights management (DRM), may be provided by digital watermarks that may be automatically and appropriately associated with each type of content. In this embodiment, the digital watermarking process may begin as publishers upload new content. As the content is accepted, several background processes automatically begin the digital watermarking process. In this embodiment, the original submitted content may be combined with an invisible digital watermark to create a new “master” file. In this embodiment, the original content submission may be removed from the system and replaced with the invisibly watermarked file to enhance security. In this embodiment, another process may then create two additional files from the new master file: a visibly watermarked version and a small thumbnail version of the visibly watermarked version.

In this embodiment, for graphical content, invisible digital watermarks may be associated with items intended to be distributed with exclusivity and royalty rights, whereas both visible and invisible digital watermarks may be added to diminished content. Digital watermarking can also be integrated with audio content and may be simply created through the use of audible and inaudible markers. Furthermore, text presented in a graphical format, for example Adobe PDF documents, can also be protected with a digital watermark. In this embodiment, each piece of digital media uploaded may be cataloged. In this embodiment, the number and type of right to use privileges each user has purchased may be tracked. In this embodiment, should the user choose to purchase a diminished right license, preferably only visibly watermarked content will be available for download. In this embodiment, the diminished content may be clearly watermarked to identify it as emanating from the content syndication system.

In this embodiment, to better understand the processes and technology involved, news agencies may be broken down into four tiers. Tier 1 includes large entities with one million+readership, such as the New York Times. Tier 2 includes midsize entities with one thousand+readership, such as the Las Vegas Sun. Tier 3 includes small entities with less than one thousand readers, such as the Whitefish Pilot. Finally, Tier 4 includes bloggers and independent reporters, with readership ranging from one thousand to ten thousand.

In this embodiment, the system may be fed by member newspapers in three ways. In this embodiment, a log-in and download application server platform (ASP) model may be set up for Tier 3 and non-media clientele. In this embodiment, an ASP plus hardware interface could be supplied on-site for Tier 2 clients. In this embodiment, Tier 1 clients could opt for a custom interface with their existing document workflow and content management applications.

In this embodiment, an editor could visit her paper's log-in page on the system web site and review the material available for that day. In this embodiment, each article, photo or illustration could be priced specifically for the viewing client. For example, a photo from the Las Vegas Sun might be posted on the system. In this embodiment, a small paper may see that a one-time usage of the Sun's photo is $5 while a mid-size paper would see it priced at $15 and a large paper would see it priced at $25.

In this embodiment, originating editors could place embargoes on material (e.g., “All Nevada papers out”, “All weeklies out”, “Only California dailies”) to protect exclusivity.

In this embodiment, the editor may be able to easily manage her publications, adding or removing content where it is needed and viewing the changes as she progresses. In this embodiment, the editor may be able to manage workflow efficiently by tracking the total progress of the publication by job and monitor the ability to meet deadlines for production.

In this embodiment, the editor may also track subscribers, advertisers and freelancers through a simple interface. In this embodiment, by simply selecting a “List Manager” tab, the editor can view the status of all three and link to the necessary detail if required. In this embodiment, this provides the editor with a quick view of important information such as the levels of revenues generated by the editor's advertisers.

In this embodiment, the content syndication service or system takes a fee-based commission on each transaction. In this embodiment, running totals on the paper's log-in page of the content syndication system web site could keep editors informed of their obligations to the content syndication system.

In this embodiment, for publishers who bought more than they sold, the content syndication system could offer the ability to have monthly automatic debits taken from bank cards or, for an extra fee, a physical or electronic invoice could be sent out.

In this embodiment, non-media could become affiliates, which could give them access to a variety of customized feeds that utilize the sophisticated meta-data and other technologies, which will be discussed later, to send them synopses of stories that pertained to their interests. In this embodiment, a firm would register a credit card number with the content syndication system and be auto-billed on a monthly basis for the next month's feed charges, plus last months' reprint rights charges, for example.

In this embodiment, a non-media firm could purchase reprint rights to a story that was in the content syndication system much the same way that a publisher buys rights—using a point-and-click methodology that would bring the content into the customer's desired location, in the customer's desired format. In this embodiment, intranet, extranet and print distribution options could be offered.

In this embodiment, the licensing engine may be based on XML processing technology. In one embodiment, a highly scalable JAVA-based platform allows for archiving and indexing of content, association of complex metadata, inclusion of digital rights management and licensing rules, source and content ranking, micro transaction and ad server capabilities.

In this embodiment, the power of XML to capture hierarchical relationships, embed context and allow precise control over information is used. However, these very attributes can make it very difficult and expensive to process. For example, XML is extensible, and application developers preferably cannot assume a pre-defined, fixed structure. Adding XML interfaces to legacy systems are temporary solutions that do not ensure the scalability, flexibility and performance that e-business applications require. They limit the platform and application independence of XML, forcing businesses to extensively retool applications to accommodate simple changes in business requirements. To avoid this, applications preferably directly process native XML.

In this embodiment, an XML data management system that manages and processes XML in its native state may be used. An example of such a system is FDX Server (“FDX”) by Snapbridge Software. In this embodiment, and based on industry standard technologies such as Java, XSL and standard RDBMS, FDX may enable solution developers to build scalable XML data repositories and XMS-based applications with precise control over information.

In this embodiment, the FDX Server may be a Java-based XML data management system that packages the complex process of XML storage, federation, query and transformation, into an integrated and extensile enterprise-class system. Data federation technology enables companies to access data for decision-intensive applications, when that data is distributed across multiple existing systems-such as, databases, applications, document repositories, flat files, mainframes, web services, and so forth. Data federation is the ability to integrate different types of data—structured, semi-structured and unstructured, within and beyond an organization—, irrespective of the way that data is stored originally, regardless of static or streaming, and regardless of location, and then to make that data actionable within the organization. Further details may be found in U.S. Patent Pub. No. 2005/0021502, the disclosure of which is hereby incorporated by reference in its entirety.

In this embodiment, the FDX Server may deliver an XML platform for rapidly developing flexible and scalable XML-based solutions for content management; print, web and wireless publishing; e-learning applications; web/wireless publishing and e-business repositories for B2B vocabularies and to enable Web Services (e.g., UDDI).

In this embodiment, FDX Server may be a native XML sever that sends and receives data from distributed applications in XML, it provides high performance XML data translation, it provides XML data storage in natural XML format and it provides access to a variety of data repositories including file subsystems, relational database management systems, legacy applications and proprietary text files.

In this embodiment, FDX Server's components may include a flexible “native” XML database system, an XML query engine, a high-performance XSL transformation engine, a data federation engine and an XML/XSL publishing framework.

In this embodiment, FDX Server persistently stores XML document elements and attributes using a relational database. In this embodiment, unlike traditional database approaches, FDX Server may eliminate the need to design database schemas and develop mapping programs. In this embodiment, XML documents can, but do not have to, have a Document Type Definition (DTD). In this embodiment, files are not stored as “blobs.” In this embodiment, on inserting, FDX Server automatically parses and XML file into its units—elements, attributes and text strings, and stores them in a fixed set of canonical tables. In this embodiment, this provides several benefits for managing XML data: The underlying data representation maintains the full XML structure, preserving the original physical structure and associated metadata. The representation retains elements (and attributes) ordering information. It may automatically validate XML documents against a DTD when one is used. It preserves the integrity of XML documents when “round-tripping”—reconstructing a document stored in the database results in exactly the same document as was originally stored. It integrates different data sources into a unified XML storage area where it can be manipulated and queried using XML standards.

In this embodiment, FDX's XML database preferably ensures transactional integrity with full ACID compliance. In this embodiment, documents can be added incrementally or loaded in bulk using a batch processor. In this embodiment, there may be no restrictions on the number or type of documents as far as they are well formed XML. In this embodiment, size of documents and the repository are only limited by the limitations of the underlying RDBMS. In this embodiment, FDX supports: Inserts, updates, copy and deletes; concurrent read and write operations; concurrent, multi-user access with support for locking; unlimited number of documents and document types; automatically handles changes to document structure and data.

In this embodiment, as with typical DBMSs, FDX provides indexing for fast data access. In this embodiment, these indices may offer improvements in query performance. In this embodiment, FDX leverages the indexing capability of the RDBMS to automatically index each element and attribute of the XML document. In this embodiment, FDX helps capture the context of the data and provides an easily searchable repository of information for e-business applications. In this embodiment, the indexing scheme is compact and efficient and can quickly retrieve a series of elements from thousands of XML documents.

In this embodiment, FDX's native XML storage is especially useful when dealing with complex document sets. Complex documents can be broken down into discrete content fragments (e.g., abstract, chapters, tables, sections, headers, sidebars, etc.), as well as metadata (e.g., author, date, document numbers). In this embodiment, FDX preserves the physical structure that may be important to document maintenance. In this embodiment, this allows separating the content from format, assemble new documents from existing components and supports collaborative content creation.

Validation is a powerful tool for ensuring that an XML document contains all of the necessary information required for an application. An XML DTD contains markup declarations that provide a grammar for a class of documents. An XML document is considered valid if it has an associated DTD and the document complies with the constraints expressed within it. In this embodiment, FDX automatically checks a document that it receives for storing to preferably ensure that it is well formed. However, to validate a document, a DTD is preferably included within the document.

In this embodiment, storing and indexing an XML document in a database is one-half of the equation. An efficient and structured way to retrieve data from XML documents stored and indexed is the other half.

In this embodiment, FDX solves several hurdles that users face when retrieving XML data. With FDX, a user can get not just a list of documents that match a query, but access the actual data. In this embodiment, to reconstruct the XML file (to its original document structure), FDX may use the saved relationships to return the original document with a minimum number of joins.

In this embodiment, FDX fully indexes each document. In this embodiment, FDX automatically allows users to access the structure of not only the whole document, but even portions of it using the W3C XPath recommendation. In this embodiment, FDX allows programs to traverse the XML tree, metaphorically, by using simple string manipulation. In this embodiment, FDX therefore quickly retrieves a specific selection of elements from thousands of XML documents.

In this embodiment, with FDX, the user doesn't need to know anything about the schema of the underlying database. Since it automatically reconstructs the XML structure, the developer does not have to worry about joins. Thus, data mining and data recovery can become a lot easier.

In this embodiment, an XML query engine that is built using the W3C XML Query algebra and the XPath specification powers FDX's retrieval capabilities. In this embodiment, the FDX query engine uses the W3C XML Query Algebra and a combination of SQL and XPath. XPath is a language for addressing parts of an XML document that is designed for use by both XSLT and XPointer.

Thus, in this embodiment, FDX query engine preferably ensures fast queries across huge amounts of XML data and documents; allows selection of multiple elements from thousands of XML documents in one operation and retrieves both the XML structure and content of an XML document.

In this embodiment, FDX's query engine supports structured queries across one or more XML documents and document types, including: element and attribute level searches; Boolean and wildcard operators; keyword and numeric range searches and queries constrained on specific types or names of documents.

In this embodiment, query results are returned as well-formed XML and can be: complete documents, individual elements or attributes, or a list of matching documents; a document fragment from a single document or consolidated from multiple documents; directly transformed using an XSL transformation. In this embodiment, this last feature delivers performance gains and reduces the complexity of business and application logic required to process XML elements. Instead of writing code to individually parse characters and then interpret them, the application can request specific XML elements, or “words” to operate on directly.

In this embodiment, FDX query requests may be submitted as XML messages. In this embodiment, FDX provides an easy to use query language called XRAP. Like XQuery, XRAP is a combination of SQL-like syntax and XPath. In this embodiment, XRAP is itself written in XML. In this embodiment, a list of elements of specific fragments of a document can be retrieved using XRAP. In this embodiment, a user can specify that the query results be returned as an XML stream, a DOM object, an array of DOM objects or a SAX DocumentHandler object. These may be part of any native XML API set.

In this embodiment, XSL is an XML-based language that is understood by XSLT, the XSL processor. It provides elements that define rules for how one XML document is transformed into another XML document. XSLT accepts as input an XML documents and an XSL document. The template rules contained in an XSL document have patterns specifying the XML tree to which the rule applies.

In one embodiment, FDX uses XSLT, a language for transforming XML documents into other XML documents. In one embodiment, FDX transformation engine may be built to support any transformation processor, for example, James Clark's XT.

In one embodiment, FDX's transformation engine incorporates an enhanced pipes-and-filters architecture to boost performance and scalabilty. In this embodiment, this may be implemented as a wrapper around the transformation processor and its multi-threaded implementation may make the transforms fast, flexible, reliable and robust.

In this embodiment, using the framework, XSL transforms can be chained together in a pipeline to perform complex transforms. Each transform can be executed in separate threads, even on different systems. This means that several transforms can be executed in parallel within a pipeline for flexibility and performance. For example, when rendering an XML document from the DocBook DTD to HTML, the TABLE section of the DocBook document can be rendered separate from the PARA part of the document. Therefore, it is conceivable to split the incoming XML document into two separate documents, run two separate transforms and then thread the resulting HTML back together. This accomplishes several objectives: the XSLT engine has to deal with two smaller documents, the transforms can be run on separate threads and the TABLE and the PARA components can be reused since the style sheets are now modular.

In this embodiment, leveraging the built-in XT processor, style sheets can be cached for re-use in subsequent requests, further improving performance. As many transformations as needed may be applied to XML documents using a combination of XSL filters to extract specific XML elements or to render the data in a personalized format. Smaller, tightly focused transform filters in a piped architecture can be recombined to produce new applications. In this embodiment, this powerful and extensible framework makes it easy to deliver new transformations and support different XML vocabularies without extensive custom programming.

In this embodiment, FDX allows developers to use their own preferred XML parser. The XML parser is used by the transformation engine to read XML documents and provide access to their content and structure and is doing its work on behalf of the calling application. In one embodiment, FDX uses James Clark's XP parser that supports both the event-based SAX (Simple API for XML) and the DOM (Document Object Model) Level 1 and Level 2 APIs. In this embodiment, developers can choose to use a different XML parser, such as Xerces from the Apache Project, or the XML4J from IBM, by simply referencing the preferred parser in a properties file.

In this embodiment, depending on the application, the data that is managed or accessed via FDX may need to be presented to a user. In one embodiment, to facilitate publishing to the Web, FDX incorporates an XML/XSL-based publishing framework that allows the complete separation of logic, content and style.

In this embodiment, FDX XML/XSL publishing framework may be designed for multi-channel publishing. In this embodiment, using XSL transformations FDX's publishing framework supports multiple client types. For example, suppose you have a web-based application that supports both browse-based clients and Wireless Application Protocol (WAP) clients. Since these clients understand different markup languages (HTML and WML respectively), your application is able to dynamically deliver content that is appropriate for each. A preferred way to handle this is to have your application produce an XML document when responding to a client. Prior to sending the response back to the client, the XML documents can then be transformed into HTML or WML depending on the client's browser type.

In this embodiment, FDX XML/XSL publishing framework delivers several benefits: Developers can create dynamic web pages by calling FDX's Servlet APIs from within HTML pages, Java Server Pages (JSP) or Active Server Pages (ASP). The Servlets retrieve the required data and transform it for presentation using XSL style sheets. Should the presentation/layout requirements change, only the XSL style sheet needs to be updated. This approach allows a greater degree of separation between logic and content, as well as content and layout. The XML data is separated from the layout, which is managed by XSL style sheets. One benefit of using the FDX publishing framework is its ability to customize the presentation and content by users, groups and devices. Multiple client devices can be supported without transcoding or additional software. Multiple XSLT processing can be specified before the data is published. This can be automated with the FDX server. The XML data that is stored does not need to be display friendly, nor contain formatting rules. The can be encapsulated in the XSL style sheet. Since FDX promotes the separation of content from layout, content can be easily re-used, so that it can be easily tailored for different audiences and for different devices.

In this embodiment, FDX's XML data retrieval technology and the XML/XSL publishing capabilities allow solution developers to build applications that deliver dynamic documents and web pages that assemble data from different XML documents in real-time. These dynamic documents can be saved as new XML instances or as “virtual” documents. New documents can be “created” by simply selecting specific XML elements from existing documents.

In this embodiment, FDX's publishing framework incorporates a simple yet powerful profiling scheme that allows personalized web pages and presentation. Leveraging username, groups and roles, FDX profile management allows different XSL style sheets to be associated with different entities (e.g., user 1 vs. user 2; admin vs. editors vs. guests, etc.). In this embodiment, FDX will automatically look for a personalized style sheet for each user so as to present the right content in the right format for that user. If no personalized style sheet exists, it may pick a group default or a system default based on policies that are easily configured by the administrator.

In this embodiment, as an XML data server, FDX provides a common access point for consumers, partners, suppliers or even an application that requires XML as a communication medium. In this embodiment, FDX provides a highly configurable and dynamic data access layer to retrieve content from legacy systems, relational databases, flat-file formats and other structured sources. For example, record sets from multiple distributed databases can be transformed into XML fragments and then assembled on the fly into an integrated XML document.

In this embodiment, the content syndication system uses Snapbridge Software's FDX Cross Media Server high-speed XML processing technology. In this embodiment, this allows for the archival, full text index/search, federation and publishing of XML-based content in high volumes in real time.

In this embodiment, FDX Cross Media Server is a multi-platform application family that improves workflow between writers, editors and production groups while reducing cost and complexity of archiving and repurposing newspaper and magazine content. FDX Cross Media Server integrates disparate data sources and different content formats to simplify and accelerate information assembly and delivery across multiple channels, including print, broadcast, web and wireless.

In this embodiment, with support for multiple computing platforms, including Windows, Linux and OSX, the highly scalable FDX Cross Media Server offers greater interoperability and content indexing, giving organizations the flexibility to created content once and then publish it in many formats with higher quality and lower cost.

In this embodiment, FDX Cross Media Server provides full text indexing of any type of XML document. Native support is provided for NITF, DocBook and NCBI. Support for binary metadata includes JPEGs and PDFs.

In this embodiment, true XML database core allows for quick access to content, leveraging hierarchical organization of data so reusability for cross media publishing is possible.

In this embodiment, complex searches are possible using Boolean operators such as AND, NOT and OR with proximity of keywords. Additionally filtering of items by source, headline, byline, date, section and page is provided.

In this embodiment, FDX Cross Media Server allows users to store and index files with the XMP metadata standard.

In this embodiment, FDX Cross Media Server provides the ability to load thousands of RSS feeds with configurable settings per URI, including update frequency and custom keywords.

In this embodiment, FDX Cross Media Server allows a user to save multiple search results in custom baskets that can be exported to a user's desktop.

In this embodiment, using standard style sheets, a custom look and feel for specific applications or use cases is provided.

In this embodiment, WebDAV Delta V Support in FDX Cross Media Server allows for the creation of a virtual network place on a desktop. A user can drag and drop files from the archive, allowing desktop applications such as Adobe in-Design and in-Copy to save directly to the archive.

In this embodiment, configurable security in FDX Cross Media Server provides the opportunity to create dedicated users and groups, with varying rights from read-only to editorial.

In this embodiment, a hardware interface may be a standard Intel-type computer housed in a low-profile case. In this embodiment, the publisher could place the hardware interface in their server room and attach the network cable. After set-up, this device would then be in communication with the content syndication system through a network, such as the Internet. In this embodiment, the hardware interface would run the Linux operating system and a customized editorial workflow system. In this embodiment, the hardware interface would retrieve content from the publisher's systems and make it available to the content syndication system. The publisher's editors or managers would make a copy of the material they wish to be syndicated and place it into the target directory. Any new material appearing in the directory would be copied from the publisher's system into the hardware interface. Software in the hardware interface would transform any existing markup language to XML, and then, the interface would notify the main servers at the content syndication system provider that it has new material and the two systems would then negotiate a transfer of metadata. In this embodiment, the original material would reside on the hardware interface at the publisher's site and the content syndication service network would set up peer-to-peer distribution. In this embodiment, all the content syndication provider's network would store and manage would be metadata and thumbnails.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

What is claimed is:

1. A content syndication system, comprising:
a server computer,
a client device,
a plurality of distributed content storage devices, and
a licensing engine associated with the server computer, the client device and the content storage device,
wherein the licensing engine is configured to communicate with the server computer, the client device and the content storage device.

2. The system of claim 1, wherein the client device comprises a browser.

3. The system of claim 1, wherein the plurality of distributed content storage devices are configured to be integrated with data federation.

4. The system of claim 1, wherein the licensing engine comprises licensing rules.

5. The system of claim 4, wherein the licensing rules are configured to the individual asset level.

6. The system of claim 1, further comprising content.

7. The system of claim 6, wherein the content comprises files associated with news stories, articles, editorials, public relations stories, advertisements, graphics, photographs, audio clips, video clips and web links.

8. The system of claim 6, wherein the content is configured to be ranked based on user feedback.

9. The system of claim 6, wherein digital watermarks are associated with the content.

10. The system of claim 1 further comprising a search engine.

11. The system of claim 1, wherein the licensing engine is configured as a Java-based XML data management system.

12. The system of claim 11, wherein the licensing engine sends and receives data in XML format.

13. The system of claim 11, wherein the licensing engine is configured to provide data storage in natural XML format.

14. The system of claim 11, further comprising an XML database system, an XML query engine, an XSL transformation engine, a data federation engine and an XML/XSL publishing framework.

15. A method of content syndication, comprising:
providing content from a content provider to a content syndication service,
establishing a price for the content,
associating licensing rules with the content,
selling the content to a buyer when the price and licensing rules have been met,
providing the content to the buyer,
providing a share of the revenue to the content provider from selling the content, and
providing a share of the revenue to the content syndication service.

16. The method of claim 15 further comprising associating a digital watermark with the content.

17. A computer-readable medium containing instructions for causing a computer to execute control of a content syndication system by a method comprising:
providing content from a content provider to a content syndication service,
establishing a price for the content,
associating licensing rules with the content,
selling the content to a buyer when the price and licensing rules have been met,
providing the content to the buyer,
providing a share of the revenue to the content provider from selling the content, and
providing a share of the revenue to the content syndication service.
